(19) United States
(12) Patent Application Publication
(10) Pub. No.: US 2017/0338501 A1
(43) Pub. Date: Nov. 23, 2017

(54) FUEL CELL SYSTEM

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: GINO PAGANELLI, Clermont-Ferrand (FR); VINCENT BRAILLARD, Clermont-Ferrand (FR)

(21) Appl. No.: 15/526,598

(22) PCT Filed: Nov. 26, 2015
(86) PCT No.: PCT/EP2015/077723

§ 371 Date: May 12, 2017

(30) Foreign Application Priority Data
Nov. 27, 2014 (FR) 1461550

(51) Int. Cl. H01M 8/04828; H01M 8/04111; H01M 8/0438; H01M 8/04746; H01M 8/04119; H01M 8/1018

(52) U.S. Cl. CPC H01M 8/04835; H01M 8/04753; H01M 8/04141; H01M 8/04111; H01M 8/04395; H01M 2008/1095; H01M 2250/20

(57) ABSTRACT

The invention relates to a fuel cell system comprising a stack of electrochemical cells forming a polymer ion-exchange membrane fuel cell (6), a fuel gas supply circuit and an oxidant gas supply circuit.

Said oxidant gas supply circuit comprises a compressor (3) intended to compress the ambient air before it enters the fuel cell (6), and an outlet exhaust (10) intended to discharge the gases leaving the fuel cell.

Said supply circuit is connected to the fuel cell at a first access point (7) and a second access point (8).

The system additionally comprises a switching element (11) that has two positions: a first position in which the outlet of the compressor (3) is connected to the first access point (7), and the second access point (8) is connected to the outlet exhaust (10), and a second position in which the outlet of the compressor (3) is connected to the second access point (8), and the first access point (7) is connected to the outlet exhaust (10).

The system is characterized in that it contains a moisture reservoir positioned in the oxidant gas supply circuit, upstream of the first access point (7).

### FIELD OF THE INVENTION

The present invention relates to fuel cells, in particular, but not exclusively, to fuel cells of the type having an electrolyte in the form of a polymer membrane (i.e. of the PEFC (polymer electrolyte fuel cell) type).

### PRIOR ART

It is known that fuel cells produce electrical energy directly via an electrochemical redox reaction using a fuel gas and an oxidant gas, without passing via a mechanical energy conversion step. This technology seems promising, especially for motor vehicle applications. A fuel cell comprises a stack of basic cells, each comprising an anode, a cathode and an ion-exchange membrane, which acts as an electrolyte. During the operation of a fuel cell, two simultaneous electrochemical reactions take place: an oxidation of the fuel at the anode, and a reduction of oxidant at the cathode. These two reactions produce positive and negative ions that combine together at the membrane and produce electricity in the form of a potential difference. In the case of an oxygen-hydrogen fuel cell, it is the H+ and O— ions that combine together.

The membrane-electrode assemblies, or cells, are stacked in series and separated by a bipolar plate that conducts the electrons from the anode of one cell to the cathode of the neighbouring cell. For this purpose, a channel is provided over the entire face of the bipolar plates in contact with the membrane. Each channel has an inlet through which the fuel or the oxidant enters, and an outlet through which are discharged the inert gases, the water generated by the electrochemical reaction and the residual moisture of the hydrogen, for its part. Subsequently, the expression “cathode channel” will denote a channel in contact with the cathode of a cell.

The supply of oxidant gas, in particular in the case where air is used, is carried out by means of a compressor, located in a gas circuit upstream of the fuel cell. It has been observed, due to the compression, that the gases leaving the compressor are hot and dry, and therefore have a tendency to dry out the polymer membrane, which gives rise to a drop in the performance of the fuel cell, and degrades said membrane. In fact, the proton conductivity of the membrane increases with humidity, and it is therefore useful to maintain a certain moisture level in order to obtain enhanced performance levels.

It is therefore useful to humidify the gases before they reach the membrane. For this purpose, humidifiers are known in which the moisture contained in the gases leaving the fuel cell is transferred, via permeation, to the dry gases entering the fuel cell. These humidifiers are in the form of housings of relatively large size. Furthermore, in order to enable the permeation, a membrane, for example made of Nafion®, is used. Such membranes prove to be relatively expensive. Moreover, it has been observed that with such humidification, the humidity was not uniform in the channel for transporting the gases located on the bipolar plate of the fuel cell. Indeed, the pre-humidified gas entering the channel has a tendency to become further loaded with moisture throughout the channel, which results in a much higher humidity at the outlet than at the inlet of the channel.

The objective of the present invention is therefore to propose a solution for humidifying the gases circulating in the cathode channel of a fuel cell while resolving the drawbacks of the prior art.

### BRIEF DESCRIPTION OF THE INVENTION

The invention thus proposes a fuel cell system comprising a stack of electrochemical cells forming a polymer ion-exchange membrane fuel cell, a fuel gas supply circuit and an oxidant gas supply circuit,
said oxidant gas supply circuit comprising a compressor intended to compress the ambient air before it enters the fuel cell, and an outlet exhaust intended to discharge the gases leaving the fuel cell,
said supply circuit being connected to the fuel cell at a first access point and a second access point,
the system additionally comprising a switching element that has two positions: a first position in which the outlet of the compressor is connected to the first access point, and the second access point is connected to the outlet exhaust, and a second position in which the outlet of the compressor is connected to the second access point, and the first access point is connected to the outlet exhaust, and the system being characterized in that it comprises a moisture reservoir positioned in the oxidant gas supply circuit, upstream of the first access point (7).

Such a system makes it possible, as explained subsequently with the aid of the figures, to retain a good humidification of the membrane, while refraining from using a bulky and expensive humidifier such as that used in the prior art.

It is known that the water generated by the electrochemical reaction in a fuel cell is generally produced uniformly over the entire surface of the membrane of one cell. On the other hand, added to this water produced by the operation of the fuel cell is the water transported by the gases circulating in the channels. Consequently, it has been observed that the amount of total water, and therefore the humidity, was not uniform over the active surface, and increased in the flow direction of the gas.

However, in a system according to the present invention, the flow direction of the gases varies depending on the position of the switching element, which leads to a variation in humidity, especially in the case where the system according to the invention is controlled according to a periodic cycle between the first position and the second position of the switching element.

Specifically, when the switching element is in the first position, the flow of oxidant gas is in the same direction as the flow of fuel gas, this situation is referred to as “co-flow”. An example of this situation is shown in FIG. 3a where it is observed that the flow directions of the air and of the hydrogen are the same.

Conversely, when the switching element is in the second position, the flow of oxidant gas is in the opposite direction to the flow of fuel gas, this situation is referred to as “counter-flow”. An example of this situation is shown in FIG. 3b where it is observed that the flow directions of the air and of the hydrogen are opposite.

Since the humidity increases in the flow direction of the gas, in the “counter-flow” situation a relatively uniform humidity is found over the whole of the membrane. On the other hand, in the “co-flow” situation, the portion of the membrane corresponding to the inlet of the gases has a much higher degree of dryness than the portion of the membrane corresponding to the outlet of the gases.

This “co-flow”, “counter-flow” alternation therefore leads to a high hygrometric variation in the membrane-electrode assembly, and may lead to a premature degradation of the fuel cell.

Throughout the description, use will be made equally of the expressions “first position” and “co-flow”, and the expressions “second position” and “counter-flow”. The first ones of these expressions referring to the position of the switching element, whilst the second ones refer instead to the movement of the gas flowing.

However, this hygrometric variation is limited, in the present invention, by the presence of a moisture reservoir in the oxidant supply circuit, upstream of the first access point. Specifically, when the fuel cell operates in “counter-flow” position, the moisture reservoir is passed through by the gases leaving the fuel cell, and that are therefore loaded with moisture. During this phase, the moisture reservoir becomes laden with water. Then, when the fuel cell operates in “co-flow” position, the moisture is returned to the gas before the entry thereof into the fuel cell, which has the result of greatly limiting the moisture variations experienced by the membranes.

In one preferred embodiment, the moisture reservoir is composed of a highly hygroscopic material, for example honeycomb-structured paper and cotton fibre. In another example, the use of cordierite-based materials may be envisaged. The volume of the moisture reservoir is preferentially adapted as a function of the power of the fuel cell. For example, for a 10 kW fuel cell, the moisture reservoir consists of paper fibre and has a volume of around 250 cm³. In one preferred embodiment, the electrochemical cells are separated by bipolar plates, a channel being made in each face of a bipolar plate for the circulation of the fuel and oxidant gases, characterized in that the first and second access points form an inlet and an outlet of a channel. Thus, when the switching element is located in the first position, the gas circulates in the channel from the first point to the second point, and vice versa when the switching element is located in the second position.

In one preferred embodiment, the switching element is a four-way valve. This valve may be a monostable or bistable valve.

It was observed that the dynamics of the valve, namely the switching time from one position to another, had an impact on the duration of the break in the oxidant gas inlet flow during a change of position. However, a prolonged break in the inlet flow leads to a temporary shortage of oxidant, and to a break in power at the outlet of the fuel cell.

To overcome this, in one preferred embodiment, the valve is equipped with a permanent-magnet angular motor, the operation of which will be described in detail subsequently with the aid of figures. This motor enables a faster switching, and is used so as to minimize the time of interruption of the oxidant gas supply at the inlet of the fuel cell. Advantageously, the motor is installed so that the axis of the motor is directly connected to the axis of the four-way valve. It is specified here that the feature that consists in using such a motor coupled with a switching element could be claimed independently of the use of a moisture reservoir as described above. In another preferred embodiment, the system additionally comprises two pressure sensors installed in the oxidant gas supply circuit, between the switching element and the first and second access points respectively. These pressure sensors make it possible to permanently check the correct operation of the valve, by comparing the pressures present at the inlet and the outlet of the fuel cell. Alternatively, it is also possible to check the regular reversal of the flow direction of the air by correlation with a measurement of the temperature of the air at one of the two access points of the fuel cell. Specifically, since the air passing through the fuel cell is heated by the latter, the reversal of the flow direction leads to a reversal of the change tendency of the air temperature, measured at an access point of the fuel cell.

In another advantageous embodiment, the switching element is installed in an end plate of the fuel cell that also comprises one or more systems for managing and/or controlling the fuel cell, or at least one component of such a system. Such a plate will be referred to as a “system plate” in the remainder of the description. Such positioning makes it possible to increase the compactness of the whole of the fuel cell system, and also makes it possible to facilitate the integration of the various components.

Moreover, the positioning of the switching element in the system plate, which is less exposed to external climatic conditions, makes it possible to guarantee an operation of the switching element irrespective of the outside temperature to which the fuel cell is subjected. Specifically, it has been observed that during the start-up of the fuel cell at negative temperatures, the switching of the switching element was sometimes rendered impossible by moisture residues converted to ice. Moreover, the positioning of the switching element in the system plate makes it possible, due to the immediate proximity, to minimize the volume of the lines between the switching element and the air supply channels of the fuel cell. Thus, the volume of depleted air leaving the fuel cell that is reintroduced at each reversal of the flow direction of the air is reduced and consequently makes it possible to minimize the break in power mentioned above.

The invention also relates to a process for controlling a fuel cell system according to the invention, the process comprising the step of controlling the switching element so as to move it from the first position to the second position according to a regular cycle. This cycle has, in one preferred embodiment, a duration of between a few seconds and a few minutes, for example between 15 and 30 seconds.

More preferably, the control process is such that this regular cycle is asymmetric, that is to say that the time during which the switching element rests in the first position is different from the time during which it rests in the second position. This asymmetry makes it possible to take into account the non-symmetric nature of the internal behaviour of the fuel cell given that the flow direction of the hydrogen gas is not itself reversed. It is understood that in the “counter-flow” position, the incoming air flows in the same direction as the outgoing hydrogen gas, and therefore withdraws moisture from it across the membrane. This situation is favourable for the humidification of the membrane on the air side and for the filling of the moisture reservoir, this phase should normally last longer than the “co-flow” phase, but cannot last too long since it would result in a drying out of the anode side. The correct equilibrium between “co-flow” and “counter-flow” duration should be regulated in order to optimize the overall performance of the fuel cell.

Furthermore, in one preferred embodiment, the process comprises a step of measuring the temperature within the fuel cell, and in this case the control of the switching element only takes place when the temperature becomes higher than a predetermined threshold. Such a characteristic makes it possible to improve the cold start-up conditions of the fuel cell. Indeed, while the fuel cell is not thawed out, the changeover is not carried out, which avoids humidifying the whole of the channel when the temperature in the fuel cell would lead to an immediate freezing of the water.

Furthermore, a control process according to the invention also makes it possible, in one preferred embodiment, to bring about a regular shortage of air at the inlet of the fuel cell. Such a shortage enables the performance of the fuel cell to be maintained over a longer duration. Specifically, the cathode of a cell is loaded with catalyst, namely a compound capable of increasing the rate of reaction, of which reaction the cathode is the site. However, the gradual oxidation of the platinum used in the catalyst of the cathode leads to a drop in performance that is expressed by a drop in voltage. The regular shortage of air enables the reaction at the platinum to reverse and become a reduction reaction, which makes it possible to preserve the performance of the catalyst.

### BRIEF DESCRIPTION OF THE FIGURES

Other advantages and features of the invention will appear with the description, given non-limitingly, of various embodiments illustrated by the following figures:

FIG. 1 shows the cathode circuit of a fuel cell system of the prior art;

FIG. 2 shows the cathode circuit of a fuel cell system according to the present invention;

FIGS. 3a and 3b, already described, show the circulation of the gases in the membrane-electrode assembly of a fuel cell, in a “co-flow” situation and a “counter-flow” situation;

FIGS. 4a and 4b show the operation of a four-way valve coupled to an angular motor according to the invention;

FIG. 5 shows the angular position of the cylinder of the valve during the switching between two positions of the valve;

FIG. 6 shows a cross-sectional view of the motor/valve assembly used in a system according to the invention.

### DESCRIPTION OF PREFERRED EMBODIMENTS OF THE INVENTION

FIG. 1 shows a system comprising a fuel cell 6 of the type having an electrolyte in the form of a polymer membrane (i.e. of the PEFC (polymer electrolyte fuel cell) or PEM (proton exchange membrane) type). The fuel cell 6 is supplied with two gases, namely the fuel (hydrogen stored or generated on board the vehicle) and the oxidant (air or pure oxygen), which gases supply the electrodes of the electrochemical cells. For this purpose, the system comprises two gas circuits: a fuel gas supply circuit, also referred to as an anode circuit, and an oxidant gas supply circuit, also referred to as a cathode circuit. FIG. 1 only represents the elements of the cathode circuit useful for understanding the invention. Of course, the present invention is not limited to these elements, and may include all the devices known to a person skilled in the art and that can be used in the case of such a fuel cell system.

Thus, the equipment comprises an air supply circuit on the cathode side. This circuit comprises an air inlet filter 1, a flow meter 2 that makes it possible to measure the flow rate of the incoming air, an air compressor 3, and a non-return valve 4 that makes it possible to prevent the gas leaving the fuel cell from coming back in the direction of the compressor 3. As indicated above, at the outlet of the compressor 3, the air is hot and dry, and would therefore run the risk, if it was introduced over too long a duration into the fuel cell, of degrading the polymer membrane. Consequently, in a conventional fuel cell, a humidifier 5, for example of the type of those of the Permapure® brand, is placed upstream of the inlet 7 which enables the entry of oxidant gas into the fuel cell.

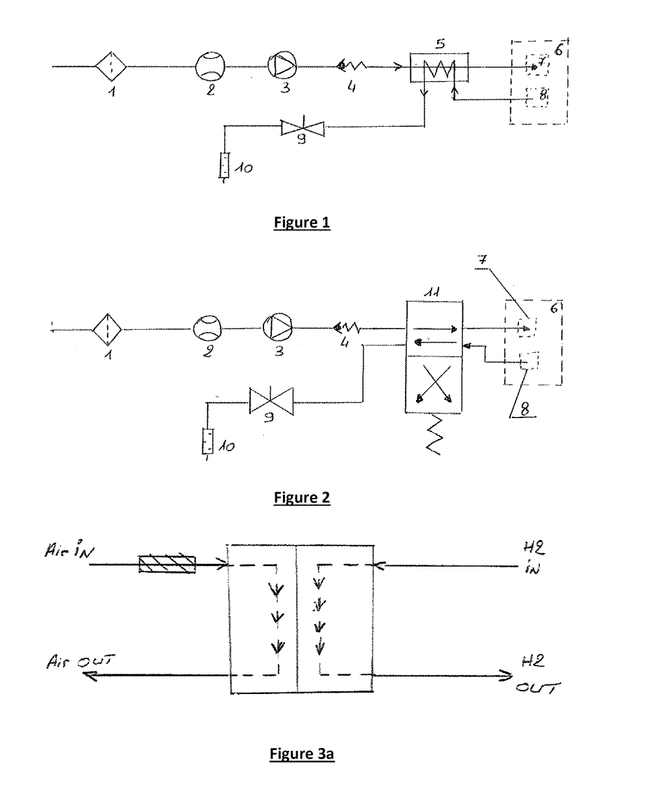

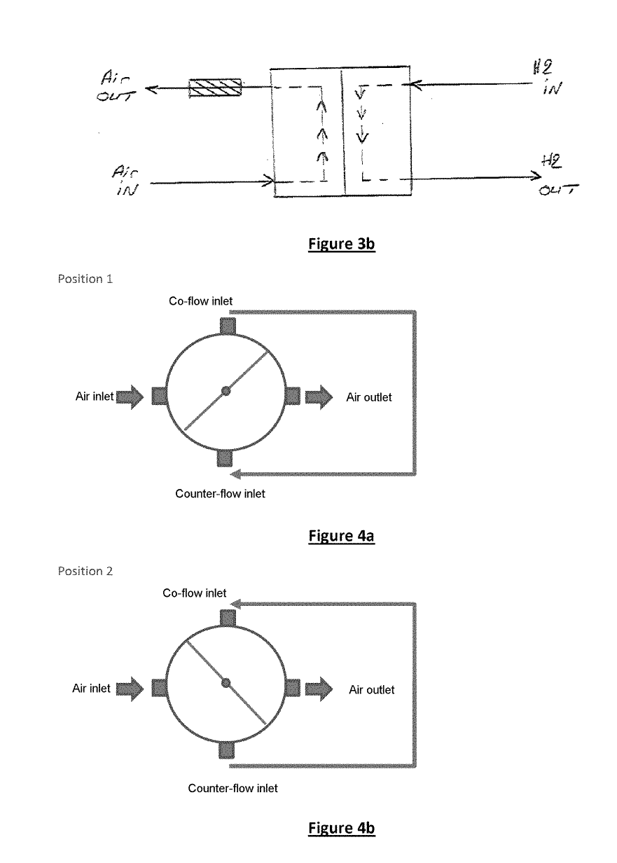

The principle of the humidifier 5 is the following: it is known that the gases leaving the fuel cell are loaded with moisture, due to the chemical half-reaction that takes place at the cathode: O₂+4 H⁺+4 e−=2 H₂O which produces water. This gas leaving through the outlet 8 of the fuel cell is introduced into the humidifier 5 at the same time as the dry gas leaving the compressor 3. The humidifier 5 comprises a polymer membrane, for example of Nafion® type. Through this membrane, a portion of the moisture present in the gases leaving the fuel cell is transferred to the dry gases before they enter the fuel cell, which makes it possible to guarantee a sufficient level of moisture in order not to damage the polymer membrane of the fuel cell 6. The gases leaving the fuel cell are then sent, after passing into the humidifier 5, to an outlet exhaust 10, via a pressure-regulating valve 9. Such a configuration has various drawbacks linked to the use of such a humidifier. Specifically, this humidifier is very bulky, since it represents a fraction of the not inconsiderable volume of the fuel cell 6 (it should be noted that the dimensions used in FIGS. 1 and 2 are not to scale). However, in the case of a mobile application, such as use in a vehicle, it is useful to be able to reduce the weight and bulkiness of the assembly as much as possible. Furthermore, the polymer membranes used in the humidifier are relatively expensive. Moreover, in the case of a use of such a humidifier, the humidity is not uniform in the channel of the bipolar plate on the cathode side. Indeed, since the gases are loaded with moisture in the course of their journey in the channel, and therefore in the course of the electrochemical reaction, this results in a very high humidity at the end of the channel.

In order to resolve these drawbacks, the present invention proposes a solution, one exemplary embodiment of which is shown in FIG. 2. This equipment comprises a valve 11, connected on one side to the non-return valve 4 and to the pressure-regulating valve 9, and on the other side to the fuel cell, at the inlet 7 and outlet 8. The valve 11 is a four-way valve, which may be monostable or bistable. The choice between the two will be made in particular in view of the energy constraints of the system, since in one case it is necessary to maintain an electric current in order to keep the valve in the second position, whereas in the other case a simple pulse makes possible to move the valve from one to the other of the positions, which proves to be advantageous in terms of energy consumption.

Owing to the control of the valve 11, the outlet of the air compressor 3 is connected alternately to the inlet 7 of the fuel cell, and the outlet 8 of the fuel cell. The terms “inlet” and “outlet” are used here in similarity with FIG. 1, but in the configuration of FIG. 2, these access points 7 and 8 are alternately inlets and outlets of the fuel cell. Thus, in a first position, the gas from the compressor 3 enters the fuel cell through the inlet 7, it travels through the channel located on the bipolar plate, in the course of which journey the electrochemical reaction takes place. The gases resulting from this reaction emerge from the fuel cell through the outlet 8 and are then sent to the outlet control valve 9. In a second position, the gas from the air compressor 3 is sent to the outlet 8, it travels through the channel located on the bipolar plate to the inlet 7, and the outgoing gases are then sent, via the valve 11, to the outlet control valve 9.

Thus, the gas circulates alternately in one direction and in the other direction in the channel. However, as explained above, during its journey in the channel, the gas is loaded with water due to the electrochemical reaction that takes place. Thus, the portion of the channel that is found at the end of the journey has a very high degree of humidity. By alternating the inlet of the gas, it is thus possible for the dry gas from the compressor 3 to enter the fuel cell through a portion of channel that has a high humidity, and thus to be loaded with water, in order not to degrade the polymer membrane. Thus, a system is provided that makes it possible to guarantee a correct humidification of the gases in contact with the membrane without it being necessary to humidifier them before their entry into the fuel cell 6. This is very advantageous in terms of cost and bulkiness, since the four-way valve is a common device, available at low cost and not being very bulky.

Moreover, alternating the gas inlet between the access points 7 and 8 makes it possible to alternate the direction of travel of the gas in the channel, and thus to make the humidity uniform throughout this channel. Thus, the humidity varies parabolically along the channel, with a high point reached at the middle of the channel, without reaching the very high levels reached at the end of the channel in a conventional system.

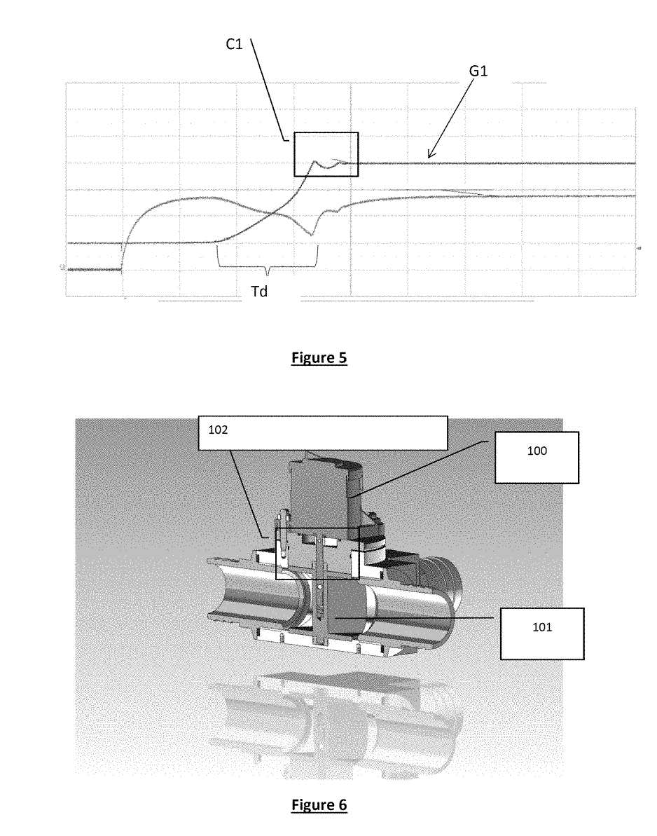

FIGS. 4a and 4b show respectively a first and second position of the four-way valve, actuated by a permanent-magnet angular motor, operating as an electromagnet. FIG. 4a corresponds to a “co-flow” situation and FIG. 4b corresponds to a “counter-flow” situation.

Preferably, the control of this valve is asymmetric. Specifically, the “co-flow” situation has a tendency to dry out the membrane more quickly than the “counter-flow” situation, and it is therefore advantageous to have a cycle in which the “co-flow” situation lasts between 5 and 15 seconds, and the “counter-flow” situation between 10 and 25 seconds.

FIG. 5 shows, on the G1 curve, the angular position of the cylinder of the valve during the switching between two positions of the valve. It is thus observed that the displacement time of the cylinder Td is less than 40 milliseconds, which makes it possible not to observe a break in power at the outlet of the fuel cell, since the capacitive effect of the fuel cell is sufficient to maintain the power during the brief switching.

Preferably, and as shown in FIG. 6, the axis of the motor 100 is coupled with the axis of the four-way valve. Moreover, elastic stops 102 are advantageously installed to absorb the energy stored by the cylinder 101 during its displacement, and to limit the rebound phenomenon, that appears in the box C1 in FIG. 5.

Thus, the present invention makes it possible to provide a fuel cell system such that the humidification of the gases is preserved, without increasing the cost and bulkiness of the system excessively.

1-10. (canceled)

11: A fuel cell system comprising:
a stack of electrochemical cells forming a polymer ion-exchange membrane fuel cell;
a fuel gas supply circuit for supplying a fuel gas;
an oxidant gas supply circuit for supplying an oxidant gas, the oxidant gas supply circuit having a first access point and a second access point, the oxidant gas supply circuit including:
a compressor that compresses ambient air before the ambient air enters the fuel cell, and
an outlet exhaust through which gas leaving the fuel cell is discharged;
a moisture reservoir positioned in the oxidant gas supply circuit upstream of the first access point; and
a switch having a first position and a second position,
wherein, when the switch is in the first position, the first access point is connected to an outlet of the compressor, and the second access point is connected to the outlet exhaust, and
wherein, when the switch is in second position, the second access point is connected to the outlet of the compressor, and the first access point is connected to the outlet exhaust.

12: The system according to claim 11, wherein the moisture reservoir is formed of a hygroscopic material.

13: The system according to claim 11,
wherein the electrochemical cells are separated by bipolar plates,
wherein each of the bipolar plates includes faces, and a channel is formed in each of the faces for circulation of the fuel gas and the oxidant gas, and
wherein the first and second access points form an inlet and an outlet of the channels.

14: The system according to claim 11, wherein the switch includes a four-way valve.

15: The system according to claim 14, wherein the switch includes a permanent-magnet angular motor coupled to the four-way valve.

16: The system according to claim 11, further comprising first and second pressure sensors installed in the oxidant gas supply circuit, the first pressure sensor being installed between the switch and the first access point, and the second pressure sensor being installed between the switch and the second access point.

17: The system according to claim 11,
wherein the switch is installed on an end plate of the fuel cell, and
wherein the system further comprises at least one fuel-cell management system.

18: A process for controlling a fuel cell system that includes a stack of electrochemical cells forming a polymer ion-exchange membrane fuel cell; a fuel gas supply circuit for supplying a fuel gas; an oxidant gas supply circuit for supplying an oxidant gas, the oxidant gas supply circuit having a first access point and a second access point, the oxidant gas supply circuit including a compressor that compresses ambient air before the ambient air enters the fuel cell, and an outlet exhaust through which gas leaving the fuel cell is discharged; a moisture reservoir positioned in the oxidant gas supply circuit upstream of the first access point; and a switch having a first position and a second position, wherein, when the switch is in the first position, the first access point is connected to an outlet of the compressor, and the second access point is connected to the outlet exhaust, and wherein, when the switch is in second position, the second access point is connected to the outlet of the compressor, and the first access point is connected to the outlet exhaust, the process comprising a step of:
controlling the switch to move from the first position to the second position according to an asymmetric regular cycle.

19: The process according to claim 18, wherein the regular cycle has a duration of 15 seconds.

20: The process according to claim 18, further comprising a step of:
measuring a temperature within the fuel cell, wherein the step of controlling the switch is performed only when the temperature of the fuel cell is higher than a predetermined threshold.
